(19) United States
(12) Patent Application Publication
(10) Pub. No.: US 2004/0187463 A1
(43) Pub. Date: Sep. 30, 2004

(54) Rotary lawnmower attachment

(76) Inventor: William Eddy, Fishkill, NY (US)

Correspondence Address: LEONARD & PROEHL, PROF. L.L.C., 3500 SOUTH FIRST AVENUE CIRCLE, SUITE 250, SIOUX FALLS, SD, 57105, US

(21) Appl. No.: 10/779,391

(22) Filed: Feb. 13, 2004

Related U.S. Application Data
(60) Provisional application No. 60/447,667, filed on Feb. 14, 2003.

(51) Int. Cl. A01D 34/52

(52) U.S. Cl. 56/295

(57) ABSTRACT

A rotary lawnmower attachment for providing blowing capability to a rotary lawnmower to assist in removing leaves and other debris through force of air generated by the rotary lawnmower blade includes fin members insertable into slots having open ends facing a center of the lawnmower blade. The fin members are positioned at each end of the lawnmower blade, extending upward and downward from the lawnmower blade, to increase air flow generated by rotation of the lawnmower blade.

### CROSS REFERENCE TO RELATED APPLICATION

This application claims the benefit of U.S. Provisional, Application No. 60/447,667, filed Feb. 14, 2003.

### BACKGROUND OF THE INVENTION

1. Field of the Invention

The present invention relates to lawn mower attachments and more particularly pertains to a new rotary lawnmower attachment for providing blowing capability to a rotary lawnmower to assist in removing leaves and other debris through force of air generated by the rotary lawnmower blade.

2. Description of the Prior Art The use of lawnmower attachments is known in the prior art. U.S. Pat. No. 3,399,519 issued to Buchanan on Sep. 3, 1968 describes a lawnmower blade having tooth-like extensions to deflect the lawnmower blade from objects that would typically damage the lawnmower blade. Another type of lawnmower attachment is U.S. Pat. No. 3,724,182 issued to Long et al. on Apr. 3, 1973 discloses spring biased paddles extending downwardly from,a trailing edge of a lawnmower blade. U.S. Pat. No. 4,320,617 issued to Fedeli on Mar. 23, 1982 discloses extensions from an upper surface of a lawnmower blade.

While these devices fulfill their respective, particular objectives and requirements, the need remains for a lawnmower attachment that is easily attached and detached to facilitate switching between conventional mowing to use of the lawnmower as a blower.

### SUMMARY OF THE INVENTION

The present invention generally comprises a lawnmower blade and fin members insertable into slots having open ends facing a center of the lawnmower blade. The fin members are positioned at each end of the lawnmower blade, extending upward and downward from the lawnmower blade, to increase air flow, generated by rotation of the lawnmower blade.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

The objects of the invention, along with the various features of novelty which characterize the invention, are pointed out with particularity in the claims annexed to and forming a part of this disclosure.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a perspective view of a new rotary lawnmower attachment according to the present invention.

FIG. 2 is an enlarged view of the blade attachments of the present invention.

### DESCRIPTION OF THE PREFERRED EMBODIMENT

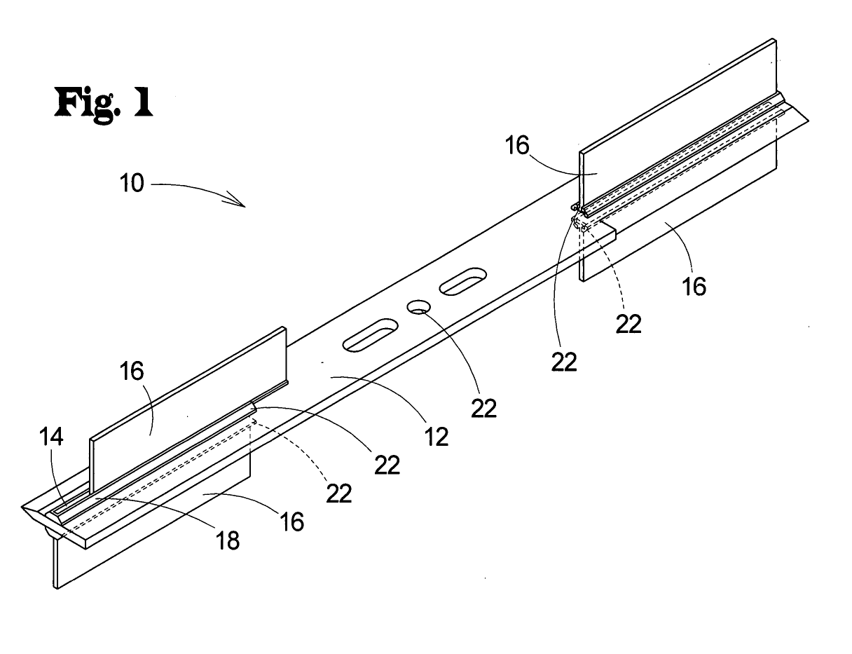

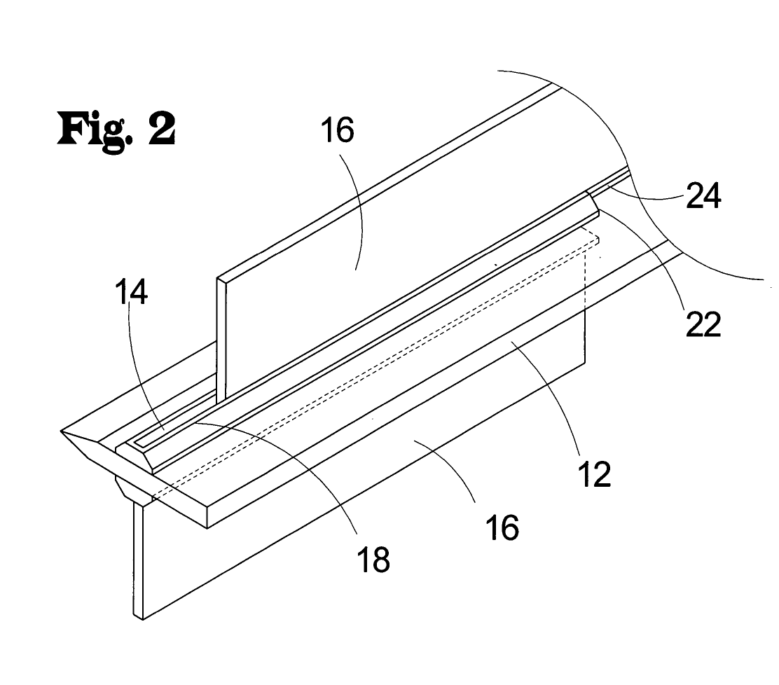

With reference now to the drawings, and in particular to FIGS. 1 and 2 thereof, a new rotary lawnmower attachment embodying the principles and concepts of the present invention and generally designated by the reference numeral 10 will be described.

As best illustrated in FIGS. 1 and 2, the rotary lawnmower attachment 10 for attachment to a rotary lawnmower 2 to provide blower capability to the rotary lawnmower 2 generally comprises a lawnmower blade 12 having a plurality of slots 14. A plurality of fin members 16 are insertable into the slots 14 such that the fin members 16 extend from the lawnmower blade 12. Thus, the fin members 16 increase air flow when the lawnmower blade 12 is rotated by the lawnmower 2.

The fin members 16 are attached to the top and bottom of the lawnmower blade 12 such that the fin members 16 extend upwardly and downwardly from the lawnmower blade 12 when the fin members 16 are coupled to the lawnmower blade 12.

In an embodiment, the slots 14 in the lawnmower blade 12 are formed by substantially U-shaped elongated raised portions 18 on the lawnmower blade 12. The raised portions 18 are positioned such that an open end 20 of each raised portion 18 opens towards a center 22 of the lawnmower blade 12. Thus, rotation of the lawnmower blade 12 urges the fin members 16 laterally outward from the center 22 to hold the fin members 16 in the slots 14.

Preferably, a base 24 of each fin member 16 is flared outwardly. The slots 14 are complimentary in shape to the base 24 of the fin members 16 for inhibiting the fin members 16 from moving out of the slots 14 during use.

For most conventional lawnmowers, when coupled to the lawnmower blade 12, each of the fin members 16 extends from the lawnmower blade 12 between about ⅝ of an inch and about ¾ of an inch for maximizing air flow and permitting vertical adjustment of the lawnmower. A length of each fin member along the lawnmower blade 12 is about 4 inches.

In use, four fin members are attached to the lawnmower blade. Two fin members are positioned at the outer portion of each side of the lawnmower blade, one on top and one on the bottom. The cutting edge of the lawnmower blade is still exposed so that cutting will still occur when the fin members are in use. The lawnmower is used in normal fashion except that increased air flow is generated by the presence of the fin members. Thus, moving the lawnmower over a surface generates air flow to blow debris away from the lawnmower.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A rotary lawnmower attachment for attachment to a rotary lawnmower to provide blower capability to the rotary lawnmower, the rotary lawnmower attachment comprising:
a lawnmower blade having a plurality of slots;
a plurality of fin members, said fin members being insertable into said slots such that said fin members extend from said lawnmower blade whereby said fin members increase air flow when said lawnmower blade rotates.

2. The lawnmower attachment of claim 1 wherein said fin members extend are arranged to extend upwardly and downwardly from said lawnmower blade when said fin members are coupled to said lawnmower blade.

3. The lawnmower attachment of claim 1 wherein said slots in said lawnmower blade are formed by substantially U-shaped elongated raised portions on said lawnmower blade.

4. The lawnmower attachment of claim 3 wherein said raised portions are positioned such that an open end of each raised portion opens towards a center of said lawnmower blade whereby rotation of said lawnmower blade urges said fin members laterally outward from said center to hold said fin members in said slots.

5. The lawnmower attachment of claim 1 wherein a base of each said fin member is flared outwardly.

6. The lawnmower attachment of claim 5 wherein said slots are complimentary in shape to said base of said fin members for inhibiting said fin members from moving out of said slots.

7. The lawnmower attachment of claim 1 wherein each of said fin members extends from said lawnmower blade between about ⅝ of an inch and about ¾ of an inch for maximizing air flow and permitting vertical adjustment of the lawnmower.

8. The lawnmower attachment of claim 1 wherein a length of each said fin member along said lawnmower blade is about 4 inches.
